(19) United States
(12) Patent Application Publication
(10) Pub. No.: US 2026/0357939 A1
(43) Pub. Date: Nov. 12, 2026

(54) Indicating Pipe Plug

(71) Applicant: John Temp Cannon, Longview, TX (US)

(72) Inventor: John Temp Cannon, Longview, TX (US)

(21) Appl. No.: 19/729,069

(22) Filed: Mar. 11, 2026

Related U.S. Application Data
(60) Provisional application No. 63/834,362, filed on Mar. 12, 2025.

(51) Int. Cl. F16L 55/11

(52) U.S. Cl. CPC F16L 55/11

(57) ABSTRACT

An indicating pipe plug comprised of a threaded plug or cap attached to a lanyard with an indicator. When the plug or cap is correctly installed in a valve or piping the indicator is not visible. When the plug is removed and suspended from the lanyard the indicator is visible. A transmitting pipe plug comprised of a threaded plug or cap attached to a lanyard with a tilt switch and transmitter inside. When the plug or cap is removed the transmitter sends a signal to an operator's monitor warning of a removed plug or cap.

### CROSS REFERENCED TO RELATED APPLICATION

This application is based on and claims the benefit of U.S. Provisional Application No. 63/834,362 filed Mar. 12, 2025, the disclosure of which is incorporated by reference herein in its entirety.

### BACKGROUND

In the petro-chemical, oil and gas, and other industries that use these types of chemicals there is an environmental standard that states open ended lines must be plugged or capped. The environmental standard states each open-ended valve or line shall be equipped with a cap, blind flange, plug or a second valve. The cap, blind flange, plug or second valve seal the open end at all times, except during operations requiring hazardous secondary material stream flow through the open-ended valve or line. Failure to plug or cap these open ended lines can lead to releases and environmental deviations. The releases often lead to safety and environmental emergencies which can lead to injuries, upsets, damages, downtime, production losses and fines. Currently the most common method is using a standard hex plug, bull plug, or a cap. These plugs can also come with a small chain to attach them to the system piping components to keep from losing the plugs. Plugs are removed for maintenance activities, tying in jumpers and sampling. Reinstalling the plugs is often missed after these activities due to operator error. If the plugs are not reinstalled after maintenance and sampling then environmental deviations, leaks or spills leading to major environmental, and safety emergencies can occur. These plugs often get missed for reinstallment after being removed because they blend in with associated equipment due to being made out of the same material. There is a need for a design to help prevent human error and to assist in identifying the removed plugs that didn't get reinstalled.

### SUMMARY

In view of the foregoing, it would be advantageous to provide a design for an indicating pipe plug. This design will help operators in the field be able to quickly locate plugs that have not been reinstalled and quickly get them installed. The highly visible coating on the indicator will be easy to identify the plugs that did not get reinstalled. The phosphorescent coating will glow in the dark allowing easy visibility of uninstalled plugs. This design will assist in plugs that are failed to be reinstalled by using a highly visible indicator or the pipe plug transmitting a signal to a computer workplace being monitored by operators or a combination of both. The present applicable here provides the requisite disclosure for an improved design for a standard pipe plug or pipe cap.

### BRIEF DESCRIPTIONS OF THE DRAWINGS

For a more complete understanding of the present disclosure and its advantages reference is now made to the following description taken in conjunction with the accompanying drawings, in which like reference numerals represent like parts:

FIG. 1. Is a side view and end view of an indicating pipe plug designed for horizontal applications and vertical applications with the plug on top of the valve or piping.

FIG. 2 is a side view and end view of an indicating pipe plug designed for a vertical application where the valve or piping is pointing down.

FIG. 3 is a side view and end view of a universal indicator that is installed between the valve or piping and a standard pipe plug or cap by use of lanyards.

FIG. 4 is a side view and end view of a transmitting pipe plug for vertical applications with the valve pointing in the down position, the drawing also includes a cut out view of the internal electronics.

FIG. 5 is a side view and end view of a universal transmitting indicator that is installed between the valve or piping and a standard pipe plug or cap by use of lanyards.

FIG. 6 is a side view and end view of an indicating and transmitting pipe plug with a cut out view of the electronics.

FIG. 7 is a side view of an indicating pipe plug installed in the top of a vertical valve with the indicator hidden and a side view of the indicating pipe plug removed revealing the indicator.

FIG. 8 is a side view of an indicating pipe plug installed in a vertical valve in the down position with the indicator hidden and a side view of the indicating pipe plug removed revealing the indicator.

FIG. 9 is a side view of an indicating pipe plug installed in a horizontal position with the indicator hidden and a side view of the indicating pipe plug removed revealing the indicator.

FIG. 10 is a side view of a universal indicator installed in a vertical valve pointing down with the indicator hidden and side view of a universal indicator with the plug removed revealing the indicator.

FIG. 11 is a side view of a transmitting pipe plug installed in a vertical valve facing up and a side view of a transmitting pipe plug removed.

FIG. 12 is a side view of a transmitting pipe plug installed in a vertical valve facing down and a side view of transmitting pipe plug removed.

### DETAILED DESCRIPTIONS

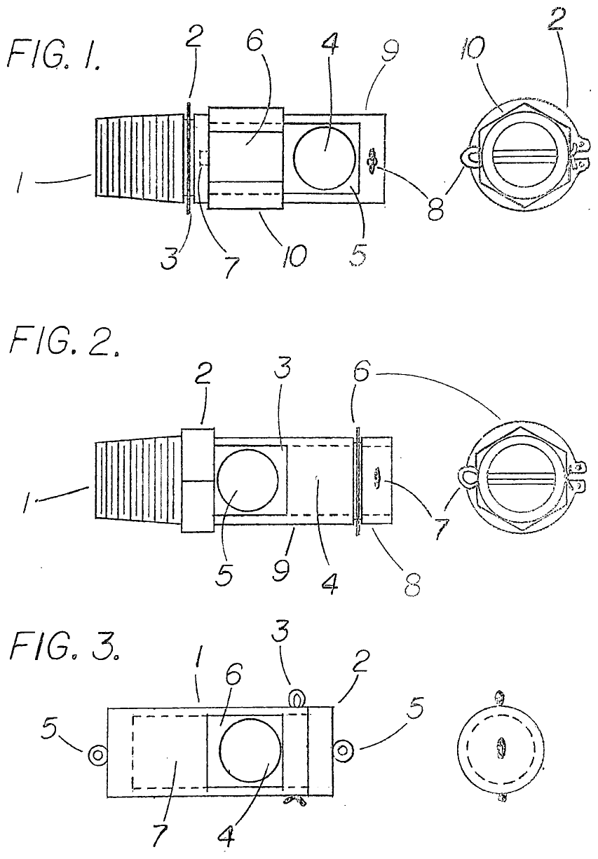

FIGS. 1-12 discussed below and the various embodiments used to describe the principles of the present disclosure in this patent document are by way of illustration only and should not be construed in any way to limit scope of the disclosure. Those skilled in the art will understand that the principles of the present disclosure may be implemented in any suitably arranged system or device.

Referring particular to FIG. 1, is an indicating pipe plug designed for a valve or piping in the vertical position with the open end pointing up and valves and piping in the horizontal position. Tapered pipe threads 1 are machined to the body 9 for securing the pipe plug to the valve, flange or piping. This design could also be a cap with female pipe threads. A snap ring 2 is used to attach the lanyard to the indicating pipe plug. The snap ring 2 fits in the grooves on the indication pipe plug and allows the plug to rotate when being tightened or loosened to prevent binding the lanyard. The indicating ball or cylinder 4 is coated with a highly visible coating that could be neon, fluorescent, bright, reflective, mirror or phosphorescence (glow in the dark). The ball 4 is shown in the open window 5 to represent the plug has been removed. The plug has a hidden cavity 6 that the ball 4 rolls into when the plug is installed, hiding it from view. The horizontal application has a small magnet 7 to keep the ball indicator 4 in the hidden position. A cotter pin or keeper pin 8 is used to hold the ball indicator 4 in the plug body 9. The plug has a hex section 10 that can be used for tightening via a wrench.

Referring particular to FIG. 2, is an indicating pipe plug designed for a valve or piping in the vertical position with the open end pointing down. Tapered pipe threads 1 are machined to the body 9 for securing the pipe plug to the valve, flange or piping. This design could also be a cap with female pipe threads. A snap ring 6 is used to attach the lanyard to the indicating pipe plug. The snap ring 6 fits in the groove on the indicating pipe plug and allows the plug to rotate when being tightened or loosened to prevent binding the lanyard. The indicating ball or cylinder 5 is coated with a highly visible coating that could be neon, fluorescent, bright, reflective, mirror or phosphorescence (glow in the dark). The ball 5 is shown in the open window 3 to indicate the plug has been removed. The plug has a hidden cavity 4 that the ball or cylinder 5 rolls or slides into when the plug is installed, hiding it from view. A cotter pin or keeper pin 7 is used to hold the ball indicator 5 in the plug housing 8. The plug has a hex section 2 that can be used for tightening via a wrench.

Referring particular to FIG. 3, is universal indicator. The universal indicator comprises of a housing 1 with a cap 2 on the end that is secured by a cotter pin or keeper pin 3. The housing 1 has rings 4 on each end to attach in the middle of lanyards. The universal indicator is mounted between the valve or piping system and the plug or cap. The indicating ball or cylinder 4 is coated with a highly visible coating that could be neon, fluorescent, bright, reflective, mirror or phosphorescence (glow in the dark). When the plug is installed the ball rolls into the hidden cavity 7 of the plug where it's not visible.

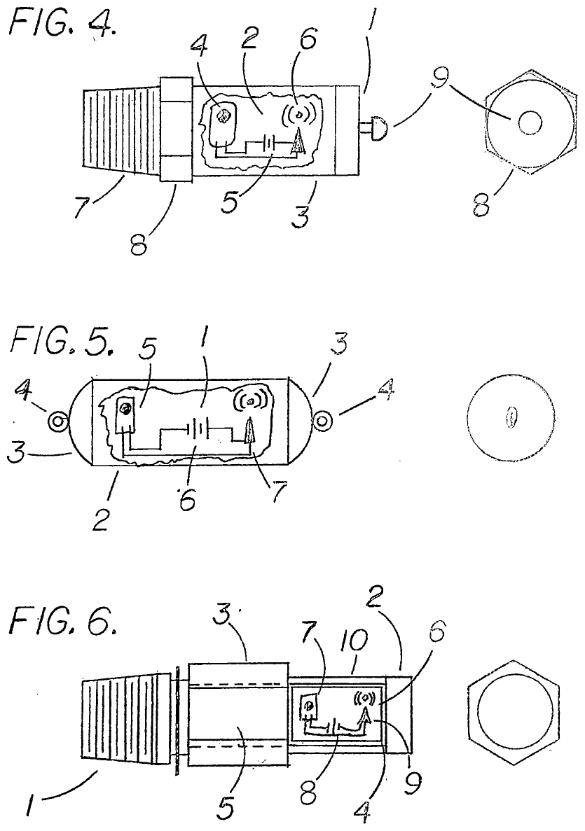

Referring particular to FIG. 4, depicts a transmitting pipe plug used on a valve or piping in the vertical position with the open end pointing down that is sealed by a cap 1 encasing electronics 4,5,6 inside the cavity 2 of the plug 3. This design could also be a cap with female pipe threads. The circuit consists of a type of switch such as a tilt switch or gyro switch 4, a power source 5 and a transmitter 6 to transmit a signal to monitors located in a remote control room being monitored by operators. The plug consists of pipe threads 7 machined to the body 3 for fastening to open ended valve or piping. The plug body 3 comprises of a hex section 8 for installing or removing via a wrench. The transmitting plug is attached to the valve or piping with a lanyard via a post 9 on the end of the plug cap 1. The tilt switch 4; inside the cavity 2 is configured in whatever position the plug will be in (vertical position on top of valve, vertical position on bottom of valve or in the horizontal position). Also note that only basic electronic components are mentioned in the description, it is understood that other components will be required to complete the design such as wires, circuit boards, etc.

Referring particular to FIG. 5, depicts a universal transmitting indicator. The indicator has electronics 5,6,7 sealed inside the cavity 1 of a body 2 with caps 3 sealing the ends. The caps 3 contain rings 4 to attach to lanyards. The electronics 5,6,7 consist of a tilt switch 5, a power source 6 and a transmitter 7. The tilt switch 5; inside the cavity 1 is configured in whatever position the plug will be in (vertical position on top of valve, vertical position on bottom of valve or in the horizontal position}. The universal transmitting indicator is installed between the plug and the valve using 2 lanyards. Also note that only basic electronic components are mentioned in the description, it is understood that other components will be required to complete the design such as wires, circuit boards, etc.

Referring particular to FIG. 6, depicts an indicating and transmitting pipe plug. The plug is attached to the valve using pipe threads 1 that are machined to the body 10. This design could also be a cap with female pipe threads. The plug housing 2 comprises of a hexagon section 3 for tightening or loosening the plug via a wrench. The housing 2 contains an indicator window 4 and hollow section 5. Inside the plug is an indicating cylinder 6 that is coated with a highly visible coating that could be neon, fluorescent, bright, reflective, mirror or phosphorescence (glow in the dark). Inside the indicating cylinder 6 is an electronic circuit consisting of a tilt switch or gyro switch 7, a power source 8 and a transmitter 9. The plug is attached to the valve via a lanyard. Also note that only basic electronic components are mentioned in the description, it is understood that other components will be required to complete the design such as wires, circuit boards, etc.

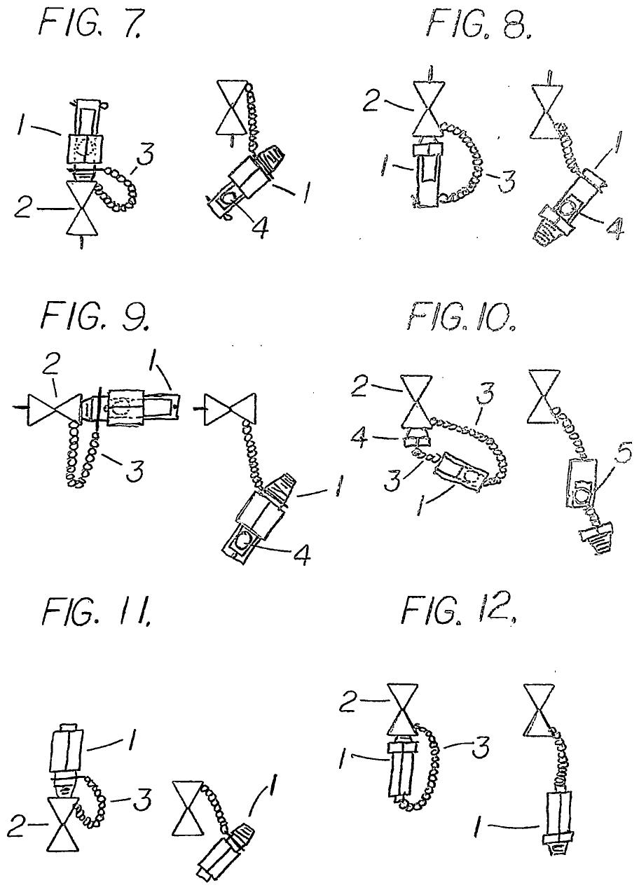

Referring particular to FIG. 7, depicts an indicating pipe plug 1 installed in the vertical position with the valve 2 facing up with a lanyard 3. This design could also be a cap with female pipe threads. The lanyard 3 could be a small chain or cable. The length of the lanyard 3 is important and should be as short as possible while still allowing the installation When the indicating pipe plug 1 is installed the indicating ball or cylinder 4 is not visible. When the indicating pipe plug 1 is removed the indicating pipe plug 1 flips over and the indicating ball rolls or cylinder 4 slides to the open cavity where it is visible.

Referring particular to FIG. 8, depicts and indicating pipe plug 1 installed in the vertical position with the valve 2 facing down with a lanyard 3. This design could also be a cap with female pipe threads. The lanyard 3 could be a small chain or cable. The length of the lanyard 3 is important and should be as short as possible while still allowing the installation. When the indicating pipe plug 1 is installed the indicating ball or cylinder 4 is not visible. When the indicating pipe plug 1 is removed the indicating pipe plug 1 flips over and the indicating ball rolls or cylinder slides 4 to the open cavity where it is visible.

Referring particular to FIG. 9, depicts and indicating pipe plug 1 installed in the horizontal position with the valve 2 facing horizontal with a lanyard 3. This design could also be a cap with female pipe threads. The lanyard 3 could be a small chain or cable. The length of the lanyard 3 is important and should be as short as possible while still allowing the installation When the indicating pipe plug 1 is installed the indicating ball or cylinder 4 is not visible and is held in place by a small magnet to keep it from vibrating out of the cavity. When the indicating pipe plug 1 is removed the indicating pipe plug 1 flips over and the indicating ball rolls or the cylinder slides to the open cavity where it is visible.

Referring particular to FIG. 10, depicts a universal indicator 1 that is installed in between the valve and the plug via 2 lanyards 3. The length of the lanyards is important and must be chosen to allow the indicator 5 to be hidden when the plug is installed. Once the plug 1 is removed the universal indicating pipe plug 1 will flip over revealing the indicating ball or cylinder 5.

Referring particular to FIG. 11, depicts a transmitting pipe plug 1 installed in a vertical valve 2 in the up position. This design could also be a cap with female pipe threads. The tilt switch is configured to be open when the transmitting pipe plug 1 is installed. The plug 1 is attached via a lanyard 3. The length of the lanyard 3 is important and is as short as possible to allow installation. When the transmitting pipe plug 1 is removed the plug 1 flips over closing the tilt switch and sending a signal inside where operators are monitoring the position of the indicating pipe plug 1. Also note that only basic electronic components are mentioned in the description, it is understood that other components will be required to complete the design such as wires, circuit boards, etc.

Referring particular to FIG. 12, depicts a transmitting pipe plug 1 installed in a vertical valve 2 in the down position. This design could also be a cap with female pipe threads. The tilt switch is configured to be open when the transmitting pipe plug 1 is installed. The plug 1 is attached via a lanyard 3. The length of the lanyard 3 is important and is as short as possible to allow installation. When the transmitting pipe plug 1 is removed the plug 1 flips over closing the tilt switch and sending a signal inside where operators are monitoring the position of the transmitting pipe plug. Also note that only basic electronic components are mentioned in the description, it is understood that other components will be required to complete the design such as wires, circuit boards, etc.

Another design in lieu of the indicating ball or cylinder could be a spring loaded telescoping plunger in the indicating pipe plug. In this design the plunger would be held hidden inside the body of the plug while the plug is installed. The lanyard would be attached to the plunger. When the plug is removed the weight of the indicating pipe plug would pull the plunger out of the body where it would become visible. The plunger would be coated with a highly visible coating that could be neon, fluorescent, bright, reflective, mirror or phosphorescence (glow in the dark). When the indicating pipe plug is reinstalled in the valve or piping the spring would retract the plunger back into the body hiding it from view. The electronic components such as the tilt switch and transmitter could also be placed inside the plunger making this transmitting pipe plug also. Also note that only basic electronic components are mentioned in the description, it is understood that other components will be required to complete the design such as wires, circuit boards, etc.

Although the present disclosure has been described with various embodiments, various changes and modifications may be suggested to one skilled in the art. It is intended that the present disclosure encompass such changes and modifications as fall within the scope of the appended claims. The indicating and transmitting pipe plugs can be machined in many different nominal pipe sizes and can be constructed of many different types of materials to allow compatibility with different chemicals that could be exposed to.

What is claimed is:

1. An indicating pipe plug comprising:
a pipe plug body; and
a visible indicator triggered when the indicating pipe plug is not installed on a pipe, valve, flange, or a pipe fitting.

2. The indicating pipe plug of claim #1, wherein the visible indicator is coated with a highly visible material.

3. The indicating pipe plug of claim #1, wherein the visible indicator is coated with a phosphorescent material.

4. The indicating pipe plug of claim #1, further comprising a lanyard to connect the indicating pipe plug and the pipe, valve, flange, or the pipe fitting.

5. The indicating pipe plug of claim #1, further comprising a spring mechanism operatively connected with the visible indicator.

6. An indicating pipe plug comprising:
a pipe plug body;
a tilt switch;
a transmitter; and
lanyard to connect the indicating pipe plug and a pipe or a pipe fitting.

7. The indicating pipe plug of claim #6, wherein the transmitter sends an electronic signal.

8. The indicating pipe plug of claim #6, wherein the visible indicator is coated with a highly visible material.
